(19) United States
(12) Patent Application Publication
(10) Pub. No.: US 2024/0120828 A1
(43) Pub. Date: Apr. 11, 2024

(54) POWER PROTECTION CIRCUIT AND POWER CONVERTING SYSTEM

(71) Applicant: GaNrich Semiconductor Corporation, Hsinchu City (TW)

(72) Inventor: Sheng-Bo WANG, Hsinchu City (TW)

(21) Appl. No.: 18/375,877

(22) Filed: Oct. 2, 2023

(30) Foreign Application Priority Data
Oct. 7, 2022 (TW) 111138242

(51) Int. Cl. H02M 1/32; H02M 1/088; H02M 3/158

(52) U.S. Cl. CPC H02M 1/32; H02M 1/088; H02M 3/158

(57) ABSTRACT

A power protection circuit includes a control voltage generation circuit, a capacitor, and a first switch. The control voltage generation circuit is electrically connected between an input terminal and a reference terminal, and generates a control voltage according to an input voltage of the input terminal. The capacitor is electrically connected between an output terminal of the power protection circuit and the reference terminal. A first terminal of the first switch is electrically connected to the input terminal, a second terminal of the first switch is electrically connected to the output terminal, a control terminal of the first switch is electrically connected to the control voltage generation circuit to receive the control voltage, and the first switch is turned on according to the control voltage to make the output terminal output the output voltage when the input voltage is greater than a predetermined value.

### CROSS REFERENCE TO RELATED APPLICATIONS

This application claims priority of Taiwan Patent Application No. 111138242 filed on Oct. 7, 2022, the entirety of which is incorporated by reference herein.

### BACKGROUND OF THE INVENTION

### Field of the Invention

The present application relates to a power protection circuit and a voltage conversion system, and particularly to a power protection circuit and a voltage conversion system with power protection function.

### Description of the Prior Art

A bridge rectifier of a power converter can rectify an input voltage of alternating current (AC) to generate a direct voltage (DC voltage) and a ground voltage, wherein the AC input voltage can be mains with 110 VAC, 220 VAC, or 230 VAC, and the ground voltage serves as a reference electric potential of 0V for the power converter.

Generally speaking, a linear power converter usually uses a high-voltage transistor as a main component to tolerate a high voltage operation condition, so that next-stage control circuits and some low-voltage components will not be damaged. However, if the transistor operates under the high voltage operation condition and is turned on, the transistor may be damaged due to power of the transistor exceeding the tolerance power thereof. Therefore, how to make the linear power converter be capable of operating normally under a higher AC input voltage (250V-265V) condition has become an important issue.

### SUMMARY OF THE INVENTION

An embodiment of the present application provides a power protection circuit. The power protection circuit includes a control voltage generation circuit, a capacitor, and a first switch. The control voltage generation circuit is electrically connected between an input terminal and a reference terminal and generates a control voltage according to an input voltage of the input terminal. The capacitor is electrically connected between an output terminal of the power protection circuit and the reference terminal. The first switch has a first terminal, a second terminal, and a control terminal, wherein the first terminal of the first switch is electrically connected to the input terminal, the second terminal of the first switch is electrically connected to the output terminal of the power protection circuit, the control terminal of the first switch is electrically connected to the control voltage generation circuit to receive the control voltage, and when the input voltage is greater than a predetermined value, the control voltage generation circuit generates the control voltage and the first switch is turned on according to the control voltage to make the output terminal of the power protection circuit output an output voltage.

According to one aspect of the present application, the control voltage generation circuit includes a first resistor, a second resistor, and a Zener diode. The first resistor is electrically connected between the input terminal and a voltage dividing node. The second resistor is electrically connected between the control terminal of the first switch and the voltage dividing node. The Zener diode is electrically connected between the voltage dividing node and the reference terminal, wherein when the input voltage is greater than the predetermined value, the control voltage is generated at a terminal of the second resistor electrically connected to the control terminal of the first switch, and the predetermined value is a breakdown voltage of the Zener diode.

According to one aspect of the present application, the control voltage generation circuit includes a second switch, a third resistor, and a fourth resistor. The second switch has a first terminal, a second terminal, and a control terminal, wherein the second terminal of the second switch is electrically connected to the reference terminal, and the control terminal of the second switch is electrically connected to a voltage dividing node. The third resistor is electrically connected between the input terminal and the voltage dividing node. The fourth resistor is electrically connected between the voltage dividing node and the reference terminal, wherein a divided voltage is generated according to the output voltage of the output terminal of the power converter divided by the third resistor and the fourth resistor.

According to one aspect of the present application, the control voltage generation circuit further includes a fifth resistor and a sixth resistor. The fifth resistor is electrically connected between the input terminal and the second terminal of the second switch. The sixth resistor has a first terminal and a second terminal, wherein the first terminal of the sixth resistor is electrically connected to the second terminal of the second switch, the second terminal of the sixth resistor is electrically connected to the control terminal of the first switch, and when the second switch is turned on according to the divided voltage, the control voltage is generated at the second terminal of the sixth resistor.

According to one aspect of the present application, the divided voltage is outputted from the voltage dividing node.

According to one aspect of the present application, the second switch is an N-type high electron mobility transistor (HEMT) or an N-type metal-oxide-semiconductor field-effect transistor (MOSFET).

According to one aspect of the present application, the first switch is a PNP-type bipolar transistor.

Another embodiment of the present application provides a voltage conversion system. The voltage conversion system includes a power converter and a power protection circuit, and the power protection circuit includes a control voltage generation circuit, a second capacitor, and a first switch. The power converter at least includes a transistor electrically connected to an output terminal of the power converter and a first capacitor, wherein the transistor is controlled by a voltage of the first capacitor. The control voltage generation circuit includes an input terminal electrically connected to the output terminal of the power converter, wherein the control voltage generation circuit is electrically connected between the output terminal of the power converter and a reference terminal through the input terminal, and generates a control voltage according to an output voltage of the output terminal of the power converter. The second capacitor is electrically connected between an output terminal of the power protection circuit and the reference terminal. The first switch has a first terminal, a second terminal, and a control terminal, wherein the first terminal of the first switch is electrically connected to the output terminal of the power converter, the second terminal of the first switch is electrically connected to the output terminal of the power protection circuit, the control terminal of the first switch is electrically connected to the control voltage generation circuit to receive the control voltage, and when the output voltage of the output terminal of the power converter is greater than a predetermined value, the control voltage generation circuit generates the control voltage and the first switch is turned on according to the control voltage to make the output terminal of the power protection circuit output an output voltage.

According to one aspect of the present application, the control voltage generation circuit includes a first resistor, a second resistor, and a Zener diode. The first resistor is electrically connected between the output terminal of the power converter and a voltage dividing node. The second resistor is electrically connected between the control terminal of the first switch and the voltage dividing node. The Zener diode is electrically connected between the voltage dividing node and the reference terminal, wherein the Zener diode includes a breakdown voltage, when the output voltage of the output terminal of the power converter is greater than the predetermined value, the control voltage is generated at a terminal of the second resistor electrically connected to the control terminal of the first switch, and the predetermined value is same as the breakdown voltage of the Zener diode.

According to one aspect of the present application, the control voltage generation circuit includes a second switch, a third resistor, a fourth resistor, a fifth resistor, and a sixth resistor. The second switch has a first terminal, a second terminal, and a control terminal, wherein the second terminal of the second switch is electrically connected to the reference terminal, and the control terminal of the second switch is electrically connected to a voltage dividing node. The third resistor is electrically connected between the output terminal of the power converter and the voltage dividing node. The fourth resistor is electrically connected between the voltage dividing node and the reference terminal, wherein a divided voltage is generated according to the output voltage of the output terminal of the power converter divided by the third resistor and the fourth resistor. The fifth resistor is electrically connected between the output terminal of the power converter and the second terminal of the second switch. The sixth resistor has a first terminal and a second terminal, wherein the first terminal of the sixth resistor is electrically connected to the second terminal of the second switch, the second terminal of the sixth resistor is electrically connected to the control terminal of the first switch, and when the second switch is turned on according to the divided voltage, the control voltage is generated at the second terminal of the sixth resistor.

According to one aspect of the present application, the second switch and the transistor are N-type high electron mobility transistors (HEMT) or N-type metal-oxide-semiconductor field-effect transistors (MOSFET).

According to one aspect of the present application, the first switch is a PNP-type bipolar transistor.

According to one aspect of the present application, the voltage conversion system further includes a DC/DC conversion circuit; the DC/DC conversion circuit is electrically connected to the output terminal of the power protection circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of a voltage conversion system in accordance with one embodiment of the present application.

FIG. 2 shows a schematic diagram of a voltage conversion system in accordance with one embodiment of the present application.

FIG. 3 shows a schematic diagram of a voltage conversion system in accordance with one embodiment of the present application illustrating a liner AC/DC voltage reducing and output current increasing circuit.

### DETAILED DESCRIPTION

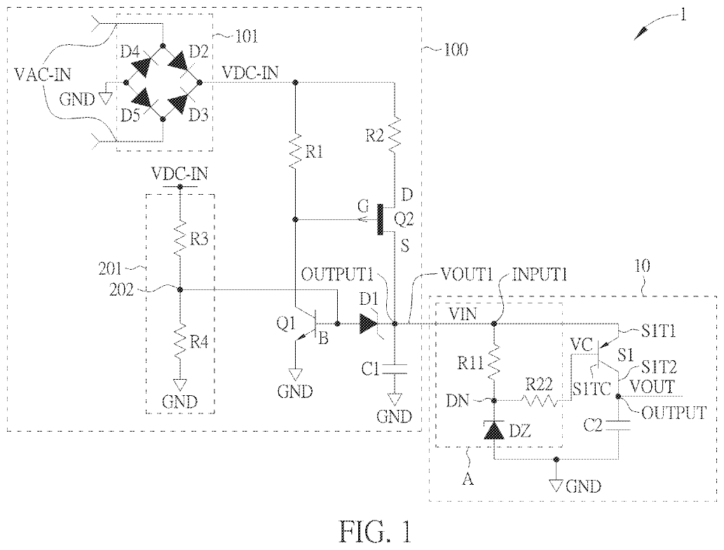

Please refer to FIG. 1. FIG. 1 shows a schematic diagram of a voltage conversion system 1 in accordance with one embodiment of the present application. As shown in FIG. 1, the voltage conversion system 1 includes a power converter 100 and a power protection circuit 10. The power converter 100 includes an output terminal OUTPUT1, and the power protection circuit 10 includes an input terminal INPUT1 electrically connected to the output terminal OUTPUT1 of the power converter 100. In one embodiment of the present application, the power converter 100 includes a bridge rectifier 101, a voltage divider circuit 201, resistors R1, R2, transistors Q1, Q2, a Zener diode D1, and a capacitor C1. In one embodiment of the present application, the bridge rectifier 101 can include four rectifier diodes D2-D5, wherein the rectifier diodes D2-D5 can be Schottky Barrier Diodes (SBD). The voltage divider circuit 201 can include resistors R3, R4. The bridge rectifier 101 rectifies an alternating current (AC) input voltage VAC-IN to generate a direct current (DC) voltage VDC-IN and a ground voltage GND. For example, the AC input voltage VAC-IN can be supply mains with 110 VAC, 220 VAC, or 230 VAC, and the ground voltage GND serves as a reference electric potential of 0V for the power converter 100. In one embodiment of the present application, the transistor Q2 can be an N-type high electron mobility transistor (HEMT) Or an N-type metal-oxide-semiconductor field-effect transistor (MOSFET), wherein labels D, G, S represent a drain, a gate, a source of the transistor Q2, respectively. In one embodiment of the present application, the transistor Q1 can be an NPN-type bipolar junction transistor (BJT), wherein a label B represents a base of the transistor Q1.

As shown in FIG. 1, a cathode of the Zener diode D1 is electrically connected to the output terminal OUTPUT1 and an anode of the Zener diode D1 is electrically connected to a base B of the transistor Q1. One terminal of the resistor R3 is electrically connected to the DC voltage VDC-IN, one terminal of the resistor R4 is electrically connected to the ground voltage GND, a connecting node 202 is electrically connected to another terminal of the resistor R3 and another terminal of the resistor R4, the connecting node 202 is located between the resistor R3 and the resistor R4, and the connecting node 202 is further electrically connected to the base B of the transistor Q1. As shown in FIG. 1, a voltage of the connecting node 202 is determined by a resistance of the resistor R3 and a resistance of the resistor R4. For example, when the resistance of the resistor R3 is 10K ohm and the resistance of the resistor R4 is 7K ohm, the voltage of the connecting node 202 is seven-seventeenth of the voltage of the DC voltage VDC-IN. Therefore, the base B electrically connected to the connecting node 202 is applied with the voltage (i.e. 7/17 multiplies the voltage of the DC power VDC-IN)) at the connecting node 202. When the DC voltage VDC-IN increases, the voltage of the base B is increased with increase of the DC power VDC-IN. When the DC voltage VDC-IN is increased to a predetermined voltage, the voltage of the base B can make the transistor Q1 turned on. Thus, a gate G of the transistor Q2 will receive the ground voltage GND through the turned-on transistor Q1, so the transistor Q2 will be turned off. After the transistor Q2 is turned off, the capacitor C1 will be no longer to be continuously charged by the DC voltage VDC-IN.

Thus, as long as the DC voltage VDC-IN is greater than the predetermined voltage, the capacitor C1 is not charged by the DC voltage VDC-IN anymore due to the transistor Q2 being turned off so that the transistor Q2 is protected from being damaged by a large current induced by an overly high drain-to-source voltage. In other words, the power converter 100 can be designed to supply power when the voltage of the DC voltage VDC-IN is around the wave trough and does not supply power when the voltage of the DC power VDC-IN is around the wave crest, wherein the charging operation is referred as trough charging in the present application. In addition, the predetermined voltage corresponds to a ration of the resistance of the resistor R3 to the resistance of the resistor R4.

As shown in FIG. 1, the power protection circuit 10 includes the input terminal INPUT1, a control voltage generation circuit A, a capacitor C2, and a first switch S1. The control voltage generation circuit A is electrically connected between the output terminal OUTPUT1 of the power converter 100 and the ground voltage GND (i.e. a reference terminal) through the input terminal INPUT1. In one embodiment of the present application, the control voltage generation circuit A can include a first resistor R11, a second resistor R22, and a Zener diode DZ. In one embodiment of the present application, the first switch S1 has a first terminal S1T1, a second terminal S1T2, and a control terminal S1TC, wherein the first terminal S1T1 of the first switch S1 is electrically connected to the output terminal OUTPUT1 of the power converter 100, the second terminal S1T2 of the first switch S1 is electrically connected to an output terminal OUTPUT of the power protection circuit 10, the control terminal S1TC of the first switch S1 is electrically connected to the second resistor R22 to receive a control voltage VC. In one embodiment of the present application, the first switch S1 can be a PNP-type bipolar transistor. As shown in FIG. 1, the first resistor R11 is electrically connected between the output terminal OUTPUT1 of the power converter 100 and a voltage dividing node DN through the input terminal INPUT1, the second resistor R22 is electrically connected between the control terminal S1TC of the first switch S1, e.g. a base of the first switch S1, and the voltage dividing node DN, and the Zener diode DZ is electrically connected between the voltage dividing node DN and the ground voltage GND. As shown in FIG. 1, the capacitor C2 is electrically connected between the output terminal OUTPUT of the power protection circuit 10 and the ground voltage GND.

As shown in FIG. 1, before an output voltage VOUT1 (equal to an input voltage VIN of the input terminal INPUT1) of the output terminal OUTPUT1 of the power converter 100 is greater than a predetermined value, the control terminal S1TC of the first switch S1 does not receive the control voltage VC. In one embodiment of the present application, the predetermined value is a breakdown voltage (e.g. 40V) of the Zener diode DZ. When the output voltage VOUT1 of the output terminal OUTPUT1 of the power converter 100 is less than the breakdown voltage of the Zener diode DZ, the control voltage VC is not transmitted to the control terminal S1TC of the first switch S1. When the output voltage VOUT1 of the output terminal OUTPUT1 of the power converter 100 is greater than the predetermined value reaching the breakdown voltage of the Zener diode DZ, the Zener diode DZ breaks down, resulting in the voltage dividing node DN having a divided voltage same as the breakdown voltage of the Zener diode DZ to further make the control voltage VC be generated at one terminal of the second resistor R22 electrically connected to the control terminal S1TC of the first switch S1, wherein when the first switch S1 is turned on according to the control voltage VC, a current flowing through the first switch S1 can charge the capacitor C2 to generate the output voltage VOUT at the output terminal OUTPUT of the power protection circuit 10. That is, before the output voltage VOUT1 of the output terminal OUTPUT1 of the power converter 100 is greater than the breakdown voltage of the Zener diode DZ, the first switch S1 is turned off and the power protection circuit 10 does not output the output voltage VOUT. Because the power protection circuit 10 outputs the output voltage VOUT after the output voltage VOUT1 of the output terminal OUTPUT1 of the power converter 100 is greater than the breakdown voltage of the Zener diode DZ, the power protection circuit 10 can ensure that the transistor Q2 is completely turned off before outputting the output voltage VOUT1 to avoid burning down of the transistor Q2.

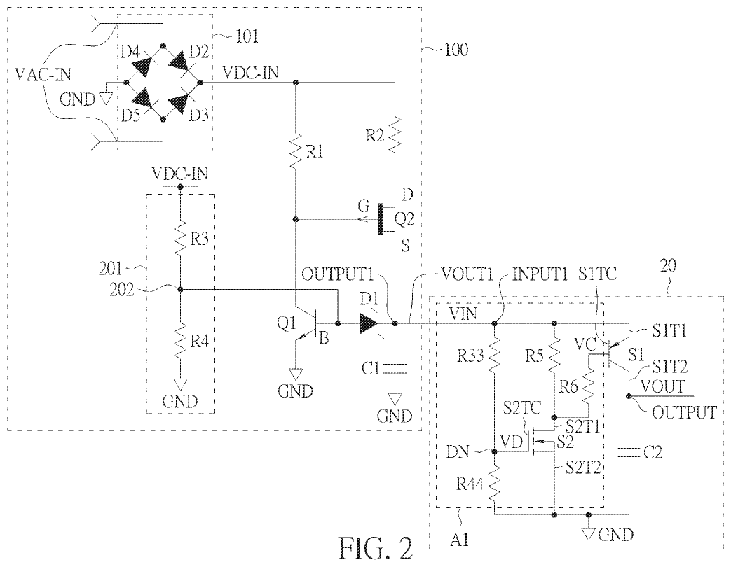

Please refer to FIG. 2. FIG. 2 shows a schematic diagram of a voltage conversion system 2 in accordance with one embodiment of the present application. The voltage conversion system 2 is similar to the voltage conversion system 1, the difference is the voltage conversion system 2 includes a power protection circuit 20 different from the power protection circuit 10. A difference between the power protection circuit 20 and the power protection circuit 10 is that a circuit structure of a control voltage generation circuit A1 included in the power protection circuit 20 is different from that of the control voltage generation circuit A of the power protection circuit 10. As shown in FIG. 2, the control voltage generation circuit A1 includes an input terminal INPUT1, a second switch S2, a third resistor R33, a fourth resistor R44, a fifth resistor R5, and a sixth resistor R6, wherein the second switch S2 has a first terminal S2T1, a second terminal S2T2, and a control terminal S2TC. As shown in FIG. 2, the second terminal S2T2 of the second switch S2 is electrically connected to the ground voltage GND, and the control terminal S2TC of the second switch S2 is electrically connected to a voltage dividing node DN; the third resistor R33 is electrically connected between the input terminal INPUT1 and the voltage dividing node DN; the fourth resistor R44 is electrically connected between the voltage dividing node DN and the ground voltage GND, wherein a divided voltage VD is generated according to the input voltage VIN of the input terminal INPUT1 divided by the third resistor R33 and the fourth resistor R44; the fifth resistor R5 is electrically connected between the input terminal INPUT1 and the first terminal S2T1 of the second switch S2; and the sixth resistor R6 has a first terminal and a second terminal, wherein the first terminal of the sixth resistor R6 is electrically connected to the first terminal S2T1 of the second switch S2, and the second terminal of the sixth resistor R6 is electrically connected to the control terminal S1TC of the first switch S1. In one embodiment of the present application, the second switch S2 can be an N-type metal-oxide-semiconductor field-effect transistor. But, in another embodiment of the present application, the second switch S2 can be an N-type GaN High Electron Mobility Transistor (GaN HEMT).

As shown in FIG. 2, the divided voltage VD is increased with increase of the output voltage VOUT1 (i.e. the input voltage VIN of the input terminal INPUT1) of the output terminal OUTPUT1 of the power converter 100. Therefore, before the input voltage VIN is greater than a predetermined value (e.g. 40V), that is, before the divided voltage VD makes the second switch S2 turned on, the control terminal S1TC of the first switch S1 does not receive the control voltage VC. When the input voltage VIN is greater than the predetermined value, the divided voltage VD makes the second switch S2 turned on to further make the control voltage VC generated at the second terminal of the sixth resistor R6, wherein when the first switch S1 is turned on according to the control voltage VC, a current flowing through the first switch S1 can charge the capacitor C2 to generate the output voltage VOUT at the output terminal OUTPUT of the power protection circuit 20. That is, before the input voltage VIN is greater than the predetermined value, the first switch S1 is turned off and the power protection circuit 20 does not output the output voltage VOUT. Because the power protection circuit 20 outputs the output voltage VOUT after the input voltage VIN is greater than the predetermined value, the power protection circuit 20 can ensure that the transistor Q2 is completely turned off before outputting the output voltage VOUT1 to avoid burning down the transistor Q2.

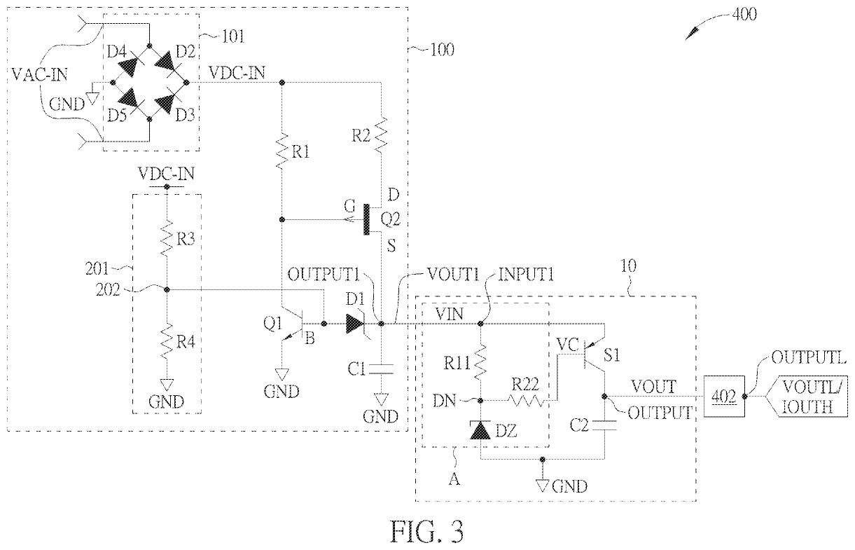

Please refer to FIG. 3. FIG. 3 shows a schematic diagram of a voltage conversion system 400 in accordance with one embodiment of the present application. Similar to the voltage conversion system 1, the voltage conversion system 400 includes the power converter 100, the power protection circuit 10. The difference is the voltage conversion system 400 further includes a DC/DC conversion circuit 402. The power protection circuit 10 is electrically connected to the output terminal OUTPUT1 of the power converter 100. The DC/DC conversion circuit 402 is electrically connected to the output terminal OUTPUT of the power protection circuit 10. The power converter 100 and the power protection circuit 10 are similar to the embodiment of FIG. 1 and can be referred to FIG. 1. In another embodiment of the present application, the power protection circuit 10 can be replaced with the power protection circuit 20. As shown in FIG. 3, the voltage conversion system 400 can perform two-stage voltage reduction on the AC input voltage VAC-IN, wherein the power converter 100 is an AC/DC converter and used for performing a first-stage voltage reduction of the two-stage voltage reduction on the AC input voltage VAC-IN to generate the output voltage VOUT1 (e.g. 40V), and the DC/DC conversion circuit 402 is used for performing a second-stage voltage reduction of the two-stage voltage reduction on the output voltage VOUT to generate a low output voltage VOUTL (e.g. 3.3V) and further used for generating a high output current IOUTH (e.g. 200 mA). Therefore, as shown in FIG. 3, an input of the voltage conversion system 400 is the AC input voltage VAC-IN (e.g. 90V-260V), and outputs of the voltage conversion system 400 are the low output voltage VOUTL (e.g. 3.3V) and the high output current IOUTH (e.g. 200 mA), wherein a load coupled to an output terminal OUTPUTL of the voltage conversion system 400 can be (for example) a wireless hotspot (Wi-Fi) module, and the voltage conversion system 400 provides the low output voltage VOUTL (e.g. 3.3V) and the high output current IOUTH (e.g. 200 mA) to the wireless hotspot (Wi-Fi) module.

To sum up, the power protection circuit disclosed by the present application outputs the output voltage only when the input voltage of the input terminal to which the power protection circuit is electrically connected is greater than the predetermined value. In addition, the voltage conversion system further disclosed by the present application can provide the low output voltage and the high output current to the load coupled to the voltage conversion system. Therefore, compared to the related arts, the power protection circuit not only can ensure that the transistor electrically connected to the input terminal is completely turned off before outputting the output voltage to avoid burning down the transistor, but can also provide the high output current to the load.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power protection circuit, comprising:
a control voltage generation circuit electrically connected between an input terminal and a reference terminal and generating a control voltage according to an input voltage of the input terminal;
a capacitor electrically connected between an output terminal of the power protection circuit and the reference terminal; and
a first switch having a first terminal, a second terminal, and a control terminal, wherein the first terminal of the first switch is electrically connected to the input terminal, the second terminal of the first switch is electrically connected to the output terminal of the power protection circuit, the control terminal of the first switch is electrically connected to the control voltage generation circuit to receive the control voltage, and when the input voltage is greater than a predetermined value, the control voltage generation circuit generates the control voltage and the first switch is turned on according to the control voltage to make the output terminal of the power protection circuit output an output voltage.

2. The power protection circuit of claim 1, wherein the control voltage generation circuit comprises:
a first resistor electrically connected between the input terminal and a voltage dividing node;
a second resistor electrically connected between the control terminal of the first switch and the voltage dividing node; and
a Zener diode electrically connected between the voltage dividing node and the reference terminal, wherein when the input voltage is greater than the predetermined value, the control voltage is generated at a terminal of the second resistor electrically connected to the control terminal of the first switch, and the predetermined value is a breakdown voltage of the Zener diode.

3. The power protection circuit of claim 1, wherein the control voltage generation circuit comprises:
a second switch having a first terminal, a second terminal, and a control terminal, wherein the second terminal of the second switch is electrically connected to the reference terminal, and the control terminal of the second switch is electrically connected to a voltage dividing node;
a third resistor electrically connected between the input terminal and the voltage dividing node; and
a fourth resistor electrically connected between the voltage dividing node and the reference terminal, wherein a divided voltage is generated according to an output voltage of an output terminal of a power converter divided by the third resistor and the fourth resistor.

4. The power protection circuit of claim 3, wherein the control voltage generation circuit further comprises:
a fifth resistor electrically connected between the input terminal and the second terminal of the second switch; and
a sixth resistor having a first terminal and a second terminal, wherein the first terminal of the sixth resistor is electrically connected to the second terminal of the second switch, the second terminal of the sixth resistor is electrically connected to the control terminal of the first switch, and when the second switch is turned on according to the divided voltage, the control voltage is generated at the second terminal of the sixth resistor.

5. The power protection circuit of claim 3, wherein the divided voltage is outputted from the voltage dividing node.

6. The power protection circuit of claim 3, wherein the second switch is an N-type high electron mobility transistor (HEMT) or an N-type metal-oxide-semiconductor field-effect transistor (MOSFET).

7. The power protection circuit of claim 1, wherein the first switch is a PNP-type bipolar transistor.

8. A voltage conversion system, comprising:
a power converter at least comprising a transistor electrically connected to an output terminal of the power converter and a first capacitor, wherein the transistor is controlled by a voltage of the first capacitor; and
a power protection circuit, comprising:
a control voltage generation circuit comprising an input terminal electrically connected to the output terminal of the power converter, wherein the control voltage generation circuit is electrically connected between the output terminal of the power converter and a reference terminal through the input terminal, and generates a control voltage according to an output voltage of the output terminal of the power converter;
a second capacitor electrically connected between an output terminal of the power protection circuit and the reference terminal; and
a first switch having a first terminal, a second terminal, and a control terminal, wherein the first terminal of the first switch is electrically connected to the output terminal of the power converter, the second terminal of the first switch is electrically connected to the output terminal of the power protection circuit, the control terminal of the first switch is electrically connected to the control voltage generation circuit to receive the control voltage, and when the output voltage of the output terminal of the power converter is greater than a predetermined value, the control voltage generation circuit generates the control voltage and the first switch is turned on according to the control voltage to make the output terminal of the power protection circuit output an output voltage.

9. The voltage conversion system of claim 8, wherein the control voltage generation circuit comprises:
a first resistor electrically connected between the output terminal of the power converter and a voltage dividing node;
a second resistor electrically connected between the control terminal of the first switch and the voltage dividing node; and
a Zener diode electrically connected between the voltage dividing node and the reference terminal, wherein the Zener diode comprises a breakdown voltage, when the output voltage of the output terminal of the power converter is greater than the predetermined value, the control voltage is generated at a terminal of the second resistor electrically connected to the control terminal of the first switch, and the predetermined value is same as the breakdown voltage of the Zener diode.

10. The voltage conversion system of claim 8, wherein the control voltage generation circuit comprises:
a second switch having a first terminal, a second terminal, and a control terminal, wherein the second terminal of the second switch is electrically connected to the reference terminal, and the control terminal of the second switch is electrically connected to a voltage dividing node;
a third resistor electrically connected between the output terminal of the power converter and the voltage dividing node;
a fourth resistor electrically connected between the voltage dividing node and the reference terminal, wherein a divide voltage is generated according to the output voltage of the output terminal of the power converter divided by the third resistor and the fourth resistor;
a fifth resistor electrically connected between the output terminal of the power converter and the second terminal of the second switch; and
a sixth resistor having a first terminal and a second terminal, wherein the first terminal of the sixth resistor is electrically connected to the second terminal of the second switch, the second terminal of the sixth resistor is electrically connected to the control terminal of the first switch, and when the second switch is turned on according to the divided voltage, the control voltage is generated at the second terminal of the sixth resistor.

11. The voltage conversion system of claim 8, wherein the second switch and the transistor are N-type high electron mobility transistors (HEMT) or N-type metal-oxide-semiconductor field-effect transistors (MOSFET).

12. The voltage conversion system of claim 8, wherein the first switch is a PNP-type bipolar transistor.

13. The voltage conversion system of claim 8, wherein the voltage conversion system further comprises a DC/DC conversion circuit; the DC/DC conversion circuit is electrically connected to the output terminal of the power protection circuit.
